(19) United States
(12) Patent Application Publication
(10) Pub. No.: US 2010/0250947 A1
(43) Pub. Date: Sep. 30, 2010

(54) SYSTEM AND METHOD OF PREVENTING SPAM BY USING PAY-CHARGE-CONTRIBUTION AND AUTHENTICATION MEANS

(76) Inventor: Kamfu Wong, Hong Kong (CN)

Correspondence Address: CARLSON, GASKEY & OLDS, P.C., 400 WEST MAPLE ROAD, SUITE 350, BIRMINGHAM, MI, 48009, US

(21) Appl. No.: 12/445,624

(22) PCT Filed: Oct. 18, 2006
(86) PCT No.: PCT/CN06/02745

§ 371 Date: May 18, 2010

(51) Int. Cl. H04L 9/32

(52) U.S. Cl. 713/175

(57) ABSTRACT

A system for preventing junk mails includes a sender email server (2-1), a recipient email server (2-2), a user terminal (3) for communicating email (4) through the sender email server (2-1) and the recipient email server 2-2, an internet communication network (6) for forwarding the email (4), and a digital certificate (5) for each of the sender email server (2-1) and the recipient email server (2-2) including a private key and a public key configured to encrypt and decrypt the email (4) with authentication in order to identify email (4) that is junk.

### CROSS-REFERENCE TO RELATED APPLICATIONS

This application is the National Stage application of PCT Application No. PCT/CN2006/002745 filed Oct. 18, 2006.

### FIELD OF THE INVENTION

This disclosure relates to internet communications and, in particular, to systems and methods concerning email communication technology over the internet.

### BACKGROUND OF THE INVENTION

With the proliferation of the internet, more and more people use electronic mail, which is also referred to as email or simply mail in short. Email has become an indispensable tool for business correspondence. In many cases, email is a replacement for facsimile because of faster speed, lower communication cost, and no charge for long distance calling. Because email is often free, some people collect a large number of email addresses of other people and then spam these email addresses with business advertisements, personal advertisements, or even adult information without the recipient's permission. From the standpoint of the email recipients, these emails are usually from strangers and the contents are usually useless advertisements. The email are commonly referred to as junk mails and are often deleted without reading. The number of junk mails is continually increasing and even outnumbers normal, useful emails. Some junk mails even carry computer virus that, once opened, infect the user's computer.

The main effect of junk mail is a loss in productivity. The email user has to spend a substantial amount of time to delete these junk mails. Junk email also wastes network bandwidth and server memory capacity. Furthermore, when deleting these junk emails, the user may accidentally delete important emails in haste, which severely affects the daily communication among people. Thus, prevention of junk email and reduction in the effects are urgent issues.

### SUMMARY OF THE INVENTION

It is therefore an object of the invention to provide an email system and relevant method for preventing junk mails.

An exemplary system for preventing junk mails includes a sender email server (2-1), a recipient email server (2-2), a user terminal (3) for communicating email (4) through the sender email server (2-1) and the recipient email server 2-2, an internet communication network (6) for forwarding the email (4), and a digital certificate (5) for each of the sender email server (2-1) and the recipient email server (2-2) including a private key and a public key configured to encrypt and decrypt the email (4) with authentication in order to identify email (4) that is junk.

### BRIEF OF DESCRIPTION OF THE DRAWINGS

FIG. 1 illustrates and email authentication system;

FIG. 2 illustrates a diagram showing email (4) communication through an email server (2) and an email authentication exchange center (1);

FIG. 3 illustrates a diagram showing email (4) communication between companies;

FIG. 4 illustrates a diagram showing another embodiment of an email authentication system;

FIG. 5 illustrates a diagram showing the steps of an embodiment employing a charge mechanism;

FIG. 6 illustrates a diagram showing another embodiment employing a charge mechanism;

FIG. 7 illustrates a diagram showing another embodiment employing a charge inquiry website (9);

FIG. 8 illustrates a diagram showing another embodiment employing a charge mechanism for emailing celebrities.

The signs in the Figures represent the same or corresponding system, device, or component part, wherein the email authentication exchange center (1) is abbreviated to exchange center (1), the email servers (2) comprise sending server (2-1) and receiving server (2-2), the digital certificates (5) comprise digital certificate (5-1) of the exchange center (1), the digital certificates (5-2) of the email servers (4) and the digital certificate (5-3) of a certain company, as well as the user terminal (3), email (4), interne (6), payment gateway (7), a bank account computer system (8), charge inquiry website (9), bank card center (88), fee-charged email server (22).

### DETAILED DESCRIPTION OF THE EMBODIMENTS

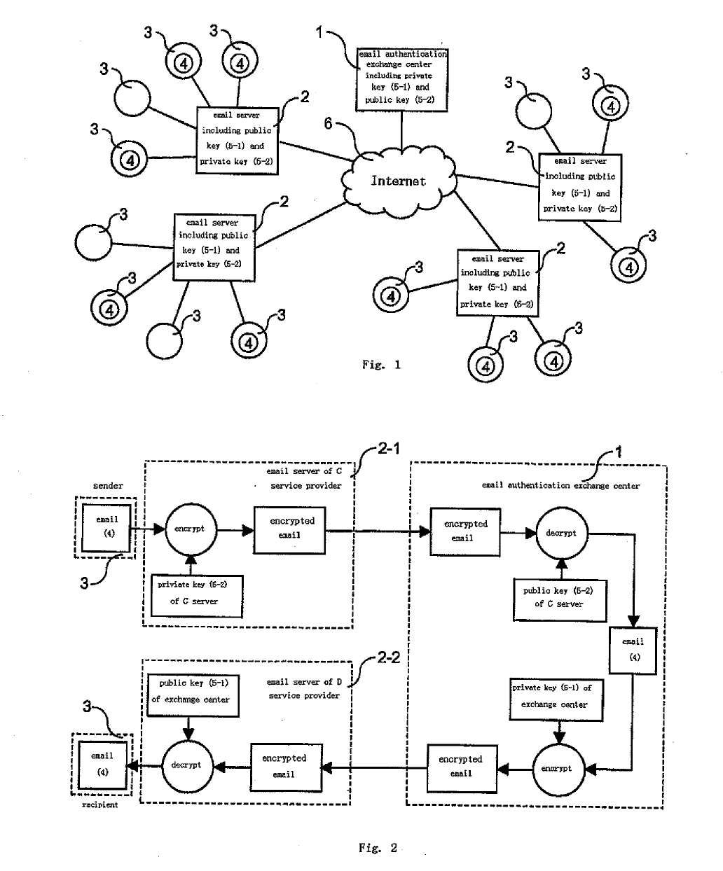

FIG. 1 is a diagram that structurally illustrates a system and method for preventing junk email using charge-payment-donation and authentication.

The system includes an email authentication exchange center (1). The exchange center (1) is an email server having relevant account management and authentication programs. The exchange center (1) also stores a public key for a digital certificate (5-2) of a respective email server (2) and a private key for its own digital certificate (5-1). The exchange center (1) decrypts encrypted email forwarded from the email server (2) with the public key for the digital certificate (5-2) corresponding to the email server (2) and then encrypts the email (4), which has already been successfully decrypted, with the private key for its own digital certificate (5-1). The exchange center (1) then forwards the email (4) to the recipient's email server (2).

The email server (2) includes relevant programs for processing encryption and decryption and stores the private key for its own digital certificate (5-2) and the public key for the digital certificate (5-1) of the exchange center (1). When an email (4) sent by a user is forwarded to the email server (2), the email server (2) encrypts the email (4) sent by the user with the private key for it's own digital certificate (5-2) and then forwards the email (4) to the exchange center (1). When an email is forwarded from the exchange center (1), the email server (2) decrypts the email with the public key for the digital certificate (5-1) of the exchange center (1) and then stores the email (4), which is successfully decrypted, into the recipient's email box, where the recipient may check the email (4) via the internet.

A user terminal (3) in the system may include a computer, a PDA, a cellular phone or the like that is able to access the internet and is set up with a program for receiving and sending emails. The user accesses the internet and logs onto the email server (2) using the user terminal (3). The user then checks or downloads the emails (4) in his/her own email box through the program for receiving and sending emails, and sends emails (4) through the email server (2).

The email (4) represents a correspondence that is sent and received through an electronic communication system and includes email (4) conveyed via internet (6) or email (4) conveyed via other communication electronic networks. Thus, the electronic mail (4) may be abbreviated to email (4) or mail (4) in this disclosure.

The internet (6) may be a communication network, such as a wide area internet network or local network and computer network. The internet (6) is used to forward emails (4) in this disclosure.

The digital certificates (5) include the digital certificate (5-1) of the exchange center (1) and the digital certificates (5-2) of the email servers (2), where the digital certificates (5) utilize the public key and private key in PKI technology (Public Key Infrastructure) to encrypt and decrypt emails. PKI technology is known and includes encrypting sent information with a private key of the digital certificate (5). The encrypted information cannot be decrypted without the public key of the very digital certificate (5). In this manner, the authenticity of the information and the identity of the information sender can be ensured.

The exchange center (1) authenticates that the received email is forwarded from the email server (2) with the digital certificate (5-2) of the email server (2), and the email server (2) authenticates that the received email is forwarded from the exchange center (1) with the digital certificate (5-1) of the exchange center (1).

The set-up of the system will now be described.

The exchange center (1) is arranged with a plurality of email servers (2). The email servers (2) may be created by adding relevant program processing encryption and decryption to traditional email servers. The exchange center (1) applies for a digital certificate (5-1) from a relevant digital certificate authentication center, and the respective email server (2) also applies for a digital certificate (5-2) from a relevant digital certificate authentication center. The respective email server (2) also registers and stores the public key of its own digital certificate (5-2) and information such as its network domain name in the exchange center (1). The exchange center (1) establishes a blacklist for any email servers that send junk mails, and thus the exchange center (1) does not forward emails (4) sent from any blacklisted email servers (2).

When the user sends an email (4) via the email server (2), the email server (2) encrypts the email (4) sent by the user with the private key of its own digital certificate (5-2), then forwards the encrypted email to the exchange center (1), which decrypts the encrypted email with the public key of the digital certificate (5-2) of the email server (2). The exchange center (1) determines that the email is forwarded from the email server (2) if the decryption is successful. After verifying the email server (2) is not a server listed on the blacklist for junk mail servers, the exchange center (1) encrypts the email (4) with the private key for its own digital certificate (5-1) and then forwards the encrypted email to the recipient's email server (2), which decrypts the received email with the public key for the digital certificate (5-1) of the exchange center (1). The recipient's email server (2) determines that the email is forwarded from the exchange center (1) if the decryption is successful and then stores the decrypted email (4) into the recipient's email box.

The exchange center (1) disposes of any forwarded email that is not encrypted with a digital certificate (5-2) or a forwarded email from an email server listed on the blacklist for junk mail servers. That is, the exchange center (1) only deals with the emails (4) sent from the email servers (2) which have already registered their digital certificates. In some cases, even an email server (2) that has not been blacklisted may be blacklisted if some people complain that this email server spams a large amount of junk mails (and the complaint is checked to be true). In this case, information such as the name of the email sever may be added to the blacklist. As a result, the added blacklisted email server (2) cannot forward emails (4) through the exchange center (1) any more.

When the email server (2) receives an email that is not forwarded from the exchange center (1), such as an email that is not encrypted with the digital certificate (5-1) of the exchange center (1), the email server (2) promptly stores the mail into another email box, such as a junk mail box. The user may choose to check these junk emails.

When most or all email servers (2) register at the exchange center (1) and use the digital certificates (5) to authenticate their identities, all normal emails (4) are forwarded to the recipient's email servers (2) through the exchange center (1), while the junk mails are forwarded directly to the junk mail box within the recipient's email server (2). Since the normal emails (4) are stored within the recipient's email box, it is not necessary for the recipients to spend time to check their junk mail boxes which contain a large amount of junk mails. Furthermore, the email server (2) is also able to revoke the user's junk mail box. That is, any email not forwarded through the exchange center (1) would be disposed directly, and thereby save memory capacity.

FIG. 2 illustrates a diagram of the steps executed by the email server (2) in forwarding email through the exchange center (1). In this example, a sender sends an email (4) to a recipient through the email server (2) of the C service provider (i.e., ISP). The recipient receives the email (4) through the email server (2) of the D service provider. The email server (2) for the sender sending email (4), namely the email server (2) of the C service provider (i.e. ISP), is abbreviated as sending server (2-1), and the email server (2) of the recipient receiving email (4), namely the email server of D service provider (i.e. ISP), is abbreviated as receiving server (2-2).

The embodiment illustrated in FIG. 2, includes the steps of:

A1. When a sender sends an email (4) to the recipient, the email (4) is forwarded to the sending server (2-1) via a user terminal (3);

A2. the sending server (2-1) encrypts this email (4) with the private key for its own digital certificate (5-2), then forwards the encrypted email to the exchange center (1);

A3. the exchange center (1) decrypts the received encrypted email with the public key for the digital certificate (5-2) of the sending server (2-1), determines that the email is forwarded from the sending server (2-1) if the decryption is successful, then promptly encrypts this email (4) with the private key for its own digital certificate (5-1), and then forwards the encrypted email to the receiving server (2-2);

A4. the receiving server (2-2) decrypts the received encrypted email with the public key for the digital certificate (5-1) of the exchange center (1), determines that the email is forwarded from the exchange center (1) if the decryption is successful, and then promptly stores the decrypted email (4) into the recipient's email box, where the recipient may read the email (4) via internet.

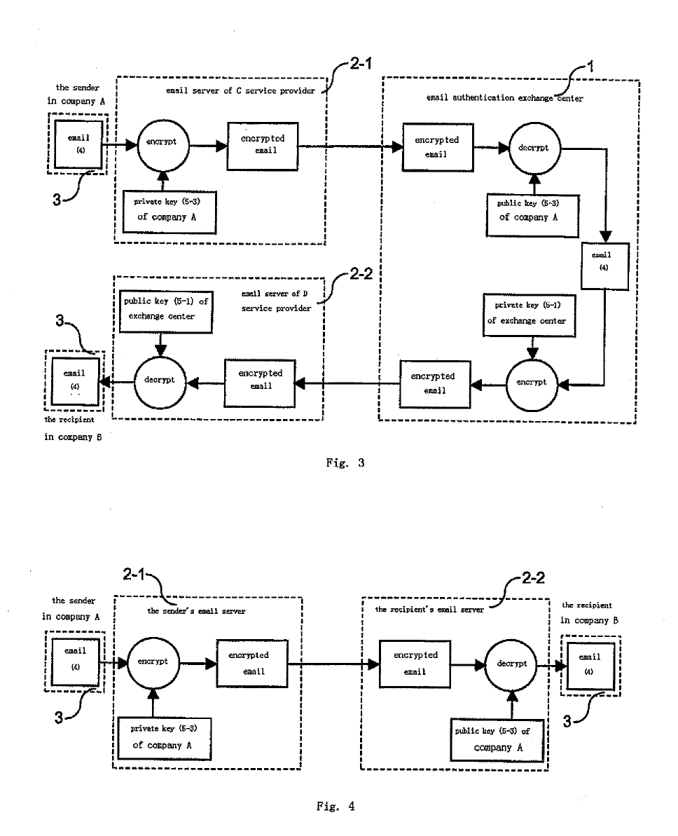

FIG. 3 illustrates a diagram of an application of the system and method described above. in which the email (4) communication is between companies. In this example, a sender in company A sends emails (4) to a recipient in company B. Company A has to apply in advance for a digital certificate (5-3) according to a predetermined system program, then registers and stores at the exchange center (1) the public key for this digital certificate (5-3), and then stores the private key for the digital certificate (5-3) within the sending server (2-1). Similarly, company B also has to apply in advance for its own digital certificate (5-3), then registers and stores at the exchange center (1) the public key for its digital certificate (5-3), and then stores the private key for the digital certificate (5-3) at the receiving server (2-2).

The embodiment illustrated in FIG. 3 includes the following steps:

B1. When a sender in company A sends an email (4) to the recipient in company B, the email (4) is forwarded to the sending server (2-1) via a user terminal (3);

B2. the sending server (2-1) encrypts the email (4) with the private key for the digital certificate of company A, then forwards the encrypted email to the exchange center (1);

B3. the exchange center (1) decrypts the received encrypted email with the public key for the digital certificate (5-3) of company A, determines that the email is sent from company A if the decryption is successful, then promptly encrypts this email (4) with the private key for the digital certificate (5-1) of its own, and then forwards the same to the receiving server (2-2);

B4. the receiving server (2-2) decrypts the received encrypted email with the public key for the digital certificate (5-1) of the exchange center (1), determines that the email is forwarded from the exchange center (1) if the decryption is successful, and then promptly stores the decrypted email (4) into the email box of the recipient in company B, where the recipient may check the email via internet.

In this embodiment, the digital certificate (5-3) of company A is applied to substitute for the digital certificate (5-2) of sending server (2-1). That is, if company A spams a large amount of junk mails, the exchange center (1) would blacklist company A. As a result, company A, if blacklisted, would not be able to send emails (4) through the exchange center (1) any more. In this manner, even if some people establish a shell company so as to apply a digital certificate (5-3) for company to send junk mails, the exchange center (1) is also able to eradicate such activities with administrative measures. For example, a service fee or deposit may be charged to for applying the digital certificate (5-3) or to register with the exchange center (1). If a company is blacklisted after spamming a large amount of junk mail, its deposit may be surrendered. In this way, the junk mails will be largely reduced since the cost for sending junk mails is increased.

FIG. 4 illustrates a diagram of another application of the system and method described above. This embodiment is a simplified version of the embodiment illustrated in FIG. 3. In this example, there is no exchange center (1), and thus the email servers (2) of each respective company authenticate each other directly. Each email server (2) has to register in advance the names of email servers (2) of other companies with which receive emails (4). The email server (2) stores the public keys for the digital certificates (5-3) for the email servers (2) of these companies. When the email server (2) of a company receives an email from those registered email servers (2), it decrypts the email with the public key for the digital certificate (5-3) of the sender's email server (2), then determines that the email is sent from the registered email server (2) if the decryption is successful, and then promptly stores the decrypted email (4) into the recipient's email box. Otherwise, the emails sent from other email servers are stored in the junk mail box. Since the mails are classified, a staff person of the company may check the emails (4) in the main mail box where the mails are typically received and check the mails in the junk mail box if time allows. In this way, the chance for the user to delete some important emails (4) when dismissing these junk mails in haste is greatly reduced.

The embodiment in FIG. 4 includes the following C steps:

C1. When a sender in company A sends an email (4) to a recipient in company B, the email (4) is forwarded to the sending server (2-1) via a user terminal (3);

C2. the sending server (2-1) encrypts the email (4) with the private key for the digital certificate (5-3) of company A, then forwards the encrypted email to the receiving server (2-2);

C3. the receiving server (2-2) decrypts the received encrypted email with the public key for the digital certificate (5-3) of company A, then determines that the email is forwarded from the sending server (2-1) of company A if the decryption is successful, and then promptly stores the decrypted email (4) into the email box of the recipient in company B, where the recipient can check the email (4) via internet.

An improvement to the embodiment of FIG. 3 may include the introduction of a charge mechanism of the sender paying to the recipient, namely the step B5. In this case, the sender pays a certain sum of money to the recipient for every email (4) he/she sends, and the exchange center (1) charges the money from the company at the sending server (2-1) on a monthly settlement basis. The exchange center (1) deposits the money, from which a service charge has been deducted, into a bank account of the company at the recipient server (2-2). Then the company at the sending server (2-1) charges relevant money from the sender, while the company at the recipient server (2-2) returns relevant money to the recipient.

As an example, the exchange center (1) registers the bank account number of respective email server (2), which also signs a contract with the exchange center (1) at the same time agreeing that the emails (4) are charged on quantity basis. The company associated with the email server (2) has to pay a certain sum of money for each mail it sends to other email servers (2) through the exchange center (1). That is, the sender's email server (2), the sending server (2-1), pays to the recipient's email server (2), the receiving server (2-2). The fee for sending and receiving emails (4) may be settled promptly, namely, the money for the fee is transferred promptly from the bank account of the sending server (2-1) to the bank account of the receiving server (2-2) at the time the email (4) is sent. Alternatively, the fee for sending and receiving emails (4) may be settled regularly, such as daily, weekly, or monthly. The amount of money to be charged from and money to be collected by respective email servers (2) is calculated during the settlement, and then the exchange center (1) pays or deposits the money with transfers between the bank accounts of the email servers via a payment gateway (7). The exchange center (1) takes out a service charge either at certain rate or of fixed amount from the money charged for sending and receiving emails (4). Since the common personal email (4) communication and the email (4) communication in business between companies are usually mutual communications, that is to say, both the sender and recipient pay for each other, and the money paid and the money received would not be substantially different, the user would usually not pay too much money.

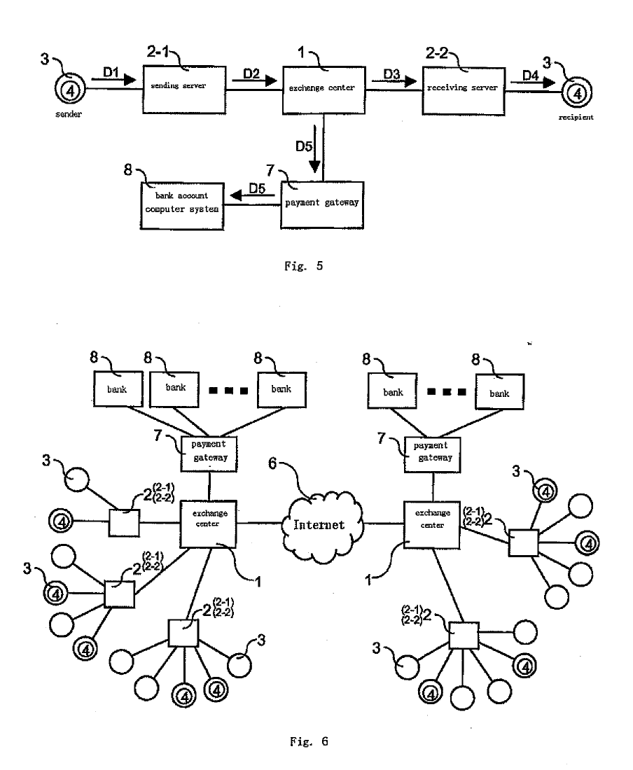

FIG. 5 illustrates a diagram of the steps of an example charge mechanism and includes the following D steps:

D1. When a sender sends email (4) to a recipient, the email (4) is forwarded to the sending server (2-1) via a user terminal (3);

D2. the sending server (2-1) encrypts this email (4) with the private key for its own digital certificate (5-2), then forwards the encrypted email to the exchange center (1), and then records this count of debt into the sender's account book;

D3. the exchange center (1) decrypts the received encrypted email with the public key for the digital certificate (5-2) of the sending server (2-1), determines that the email is sent from the sending server (2-1) if the decryption is successful, records this count of debt for sending this email into the account book of the sending server (2-1), then encrypts the decrypted email (4) with the private key for the digital certificate (5-1) of the exchange center (1) and forwards the encrypted email to the receiving server (2-2), and records the income for receiving this email into the account book of the receiving server (2-2);

D4. the receiving server (2-2) decrypts the received encrypted email with the public key for the digital certificate (5-1) of the exchange center (1), determines that the email is forwarded from the exchange center (1) if the decryption is successful, then stores the decrypted email (4) into the recipient's email box promptly for the recipient to check, and records the income for receiving this mail into the recipient's account book;

D5. during settlement, the exchange center (1), based on account book of the respective email server (2-1 or 2-2), calculates the money to be paid or the money to be received by the email servers (2-1 and 2-2) with the service charge deducted, then charges or deposits the money via transfer between the bank accounts of the email servers (2-1 and 2-2) through the payment gateway (7) and the bank account computer system (8), and the respective email servers (2), the sender email server (2-1) and the recipient email server (2-2) charge the money from or return the money to the accounts of their own users.

FIG. 6 illustrates a diagram showing another embodiment of a charge mechanism, with the establishment of exchange centers (1) at different regions. In this example, the Figure only shows the exchange centers (1) at two regions X and Y. Every exchange center (1) is in charge of exchanging emails (4) and clearing settlements or the like for the local email servers (2). When an email (4) is forwarded from region X to region Y, it is forwarded to the recipient's email box at the receiving server (2-2) through the sender's sending server (2-1), the exchange center (1) at region X, and the exchange center (1) at region Y. At the time of settlement, the exchange centers (1) at the two regions clear the settlement based on the quantity of emails (4) received and sent, then make transfers through the payment gateway (7) and the bank account computer system (8). Once the exchange centers (1) are established all over the world, all normal emails (4) would be forwarded to the recipient's email box through the exchange centers (1). In this way, the user is immune to the junk mails once the user forwards emails (4) through the email servers (2) registered at the exchange centers (1). Because the junk mails are usually sent one-way to recipients from the email-spammer, the cost of sending junk email is considerable if sent through the exchange center (1), which would become an unbearable burden to the email-spammer. If the junk mails are sent through other servers, these mails are disposed of by the recipient's email server (2) or stored into the recipient's junk mail box. Since normal emails (4) are stored into the recipient's email box, fewer people would check the junk mail box such that the email-spammer cannot convey the information within the junk mails to the recipients. As a result, few people will send junk mails with the systems disclosed herein. Charging a fee to the email sender is the best way to prevent junk mails, and furthermore, the exchange center (1) could donate all the money, from which its cost has been deducted, collected from the email senders to charity organizations. For example, the money may be donated to the charity voluntary organizations such as Doctors Without Borders and the ORBIS Sight Hospital to help those in need, which most email users surely will not object. Moreover, such donations may also be helpful in popularizing the systems disclosed herein.

Local governments may also tax the email senders through the exchange center (1), which would also increase the government's revenue. Since the objects to be taxed are only the email senders, it will neither lay burden to the citizens, nor bring effects on the local economy and may be a good way to increase the government's revenue.

FIG. 7 illustrates a diagram showing the an embodiment including an email charge inquiry website (9). This embodiment employs a mechanism of adding a self-defined donation into the fixed charge. The self-defined donation charge is a donation level set by an email address owner. The email charge inquiry website (9) provides information related to the donation charge for the email addresses at the email servers (2) all over the world, and the self-defined donation charge for an email address can be found through logging onto the email charge inquiry web site (9) and inputting the email address. The respective email server (2) classifies its email users into two groups. One group is classified as common email users, to whom the emails can be successfully sent with a payment of the fixed charge. The other group is classified as email users with the self-defined donation charge. If a person wants to send emails (4) to the email boxes of this second group, the person has to pay not only the fixed charge but also the donation charge defined by the recipient. The email server (2) also stores information, such as the email address of the email user with self-defined donation charge and the amount of money for the donation charge, into the email charge inquiry website (9), and the email address owners can change the amount of money for the self-defined donation charge at will by sending email to the email charge inquiry website. The email user may change the self-defined donation charge by sending an email (4) to the email charge inquiry website (9) through the sender email server (2-1). The content in the email may include the new amount of money for the self-defined donation charge. If an email user wants to receive fewer emails (4), the user may set a much higher amount of money for the self-defined donation charge, for example. If the chairman of the board of a company set 100 U.S. dollars as the self-defined donation charge for his/her own email address, then only those who are willing to donate 100 U.S. dollars can successfully send an email (4) to the email box of the chairman of the board. The embodiment illustrated in FIG. 7 may include the following E steps:

E1. Before sending an email (4) to the recipient, the sender logs on the email charge inquiry website (9) and inputs the recipient's email address. Then the sender views the amount of money for the self-defined donation charge set by the recipient;

E2. if the sender accepts the amount of money for the self-defined donation charge, the sender forwards the email (4) to the sending server (2-1) via a user terminal (3);

E3. the sending server (2-1) encrypts the email (4) with the private key for its own digital certificate (5-2), then forwards the encrypted email (4) to the exchange center (1) and records this count of debt into the sender's account book;

E4. the exchange center (1) decrypts the received email (4) with the public key for the digital certificates (5-2) of the sending server (2-1), determines that the email is forwarded from the sending server (2-1) if the decryption is successful, promptly records this count of debt into the account book of the sending server (2-1), then encrypts this email (4) with the private key for its own digital certificate (5-1), and then records this count of income into the account book of the receiving server (2-2);

E5. the receiving server (2-2) decrypts the received encrypted email with the public key for the digital certificate (5-1) of the exchange center (1), determines that the email is forwarded from the exchange center (1) if the decryption is successful, then promptly records this count of income into the recipient's account book, and the receiving server (2-2) verifies whether the recipient's email address is a common one or one with self-defined donation charge, and if this recipient is a common email user, the receiving server (2-2) promptly stores the decrypted email (4) into the recipient's email box, ignores steps E6-E14, and skips to step E15, while if the recipient is an email user with self-defined donation charge, then the receiving server (2-2) temporarily stores the email (4) and proceeds to step E6;

E6. the receiving server (2-2) sends to the exchange center (1) a request for paying the self-defined donation charge, where the request may include the email sender's email address, the recipient's email address, title, date and time of that email, etc.;

E7. after receiving the request for paying the self-defined donation charge, the exchange center (1) searches out the recipient's email address from the request, then promptly checks the amount of money for the donation charged for the email address on the email inquiry charge website (9);

E8. the email inquiry charge website (9) searches out information about the amount of money for the donation charged for the email address from the records it keeps, then promptly forwards to the exchange center (1) the information about the amount of money for the donation;

E9. the exchange center (1) promptly temporarily stores the information about the amount of money for the donation charge, replies to the sender with an email encrypted with the private key for its own digital certificate (5-1), where this email includes the relevant donation charge and a donation reference code and to remind the sender to pay the relevant donation charge on-line via logging on the website of the exchange center (1) within a designated time limit (such as a week), the donation reference code is a number for distinguishing different entails (4) when receiving the donation;

E10. the sender's email server (2) decrypts the reply email with the public key for the digital key (5-1) of the exchange center (1), determines that the email (4) is sent from the exchange center (1) if the decryption is successful, and this email is stored into the sender's email box;

E11. when checking the email box, the sender reads the content of the reply email, and if the sender agrees to make a donation, the sender may, within the designated time limit, log on the website of the exchange center (1), and input the sender's own email address and payment reference code, the sender finds out on the website of the exchange center (1) the recipient's email address for the email (4) sent to the sending server (2-1) described in preceding step E2 and after checking the information, the sender inputs the payment information, including information such as credit card number, valid date of the credit card or the debit card and password which is essential for on-line payment, on the payment webpage of the exchange center (1);

E12. the exchange center (1) forwards through the payment gateway (7) the payment information and the total amount of money to the bank account computer system (8) and requests for transfer of the money;

E13. the bank account computer system (8) verifies the payment information and account balance, etc., and if all information is valid, then transfers the money from the user's account provided in the payment information to the bank account of the exchange center (1), and then informs the exchange center (1) that the transfer is successful;

E14. the exchange center (1) forwards to the receiving server (2-2) the received information about successful transfer for the payment, then the receiving server (2-2) stores the decrypted email (4), which has been temporarily stored at step E5, into the recipient's email box for the recipient to check;

E15. during the settlement, the exchange center (1), based on record of receiving and sending emails at fixed charge for the respective email server (2), calculates the money to be paid or the money to be received by the email servers (2) with deduction of the service charge from the respective account, then charges or deposits the money with transfer between the bank accounts of the email servers (2) through the payment gateway (7) and the bank account computer system (8), and the respective email servers (2), the sending server (2-1) and the receiving server (2-2), charge the money from or return the money to the accounts of their own users, the exchange center (1) may donate all the money collected at step E13 with the service charged deducted to a charity organization.

In this embodiment, the exchange center (1) may donate all money collected through the donations, less the service charge deducted, to local charity organizations. The email charge inquiry website (9) may build a webpage including a rank list showing the amount of donation each email address collects, and people can, through logging on this webpage, find out the email address and person which collects the largest amount of donation. The system and method described in this embodiment is not only able to prevent junk mails, but also able to reduce the amount of emails of less importance. If a high amount for the self-defined donation charge is set, any the emails (4) received may be deemed to be of great importance. As a result, the systems and method prevents junk mails and benefits charity.

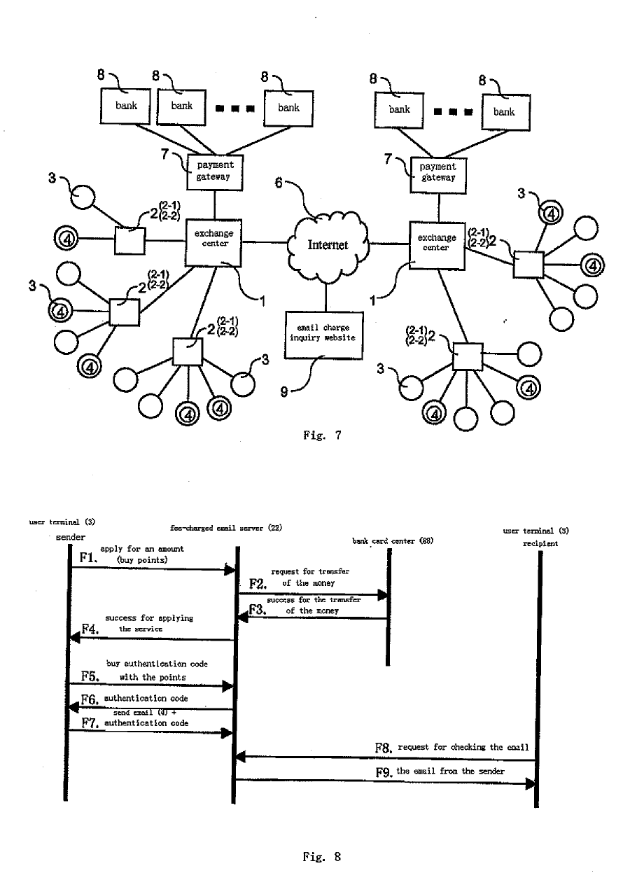

FIG. 8 illustrates steps of a fee-charged embodiment that differs from aforesaid embodiments but not including the exchange center (1) or the email charge inquiry website (9). This embodiment may be suitable for email users such as celebrities and the officials of multinational companies. Most celebrities and senior executives in business organizations are apprehensive about making their email addresses known to the public, since their email boxes would be inundated with junk mails that may reduce the utility of using email. Consequently, most of these people would like to keep their email addresses secret and for internal use only, which is thus not available for other people. Although these people are celebrities in society, it is still difficult for ordinary people to send emails (4) to them. A website for a fee-charged email server (22) may be established, where every celebrity is assigned an email box and an email address which is open to the public. Those who want to send emails (4) to these celebrities firstly have to log onto the website of the fee-charged email server (22) and pay a certain amount of fee such as 1,000 dollars, so that they can send emails (4) to those celebrities, while all the money collected by the fee-charged email server (22) with the service charge deducted would may be donated to a charity organization. Since the email sender sends the celebrity an email (4) by making a donation, the celebrity may read the content in the email (4) carefully and reply to the kindhearted donator, which is beneficial to both the celebrities and society. The embodiment illustrated in FIG. 8 may include the following F steps:

F1. Before sending an email (4) to a celebrity, the sender firstly has to open an account at the website of the fee-charged email server (22) and buy points, then the sender inputs the value of points to be bought and payment information such as the sender's credit card number, for example, 1 dollar equals to 1 point, thus the sender has to pay 1,000 for 1,000 points;

F2. the fee-charged email server (22) forwards to the bank card center (88) the sender's payment information, such as the credit card number and the amount of money to be transferred for the payment;

F3. after verifying that the payment information and the account balance are valid, the bank card center (88) transfers money from the sender's credit card account to the account of the fee-charged email server (22), then informs the fee-charged email server (22) that the transfer is successful;

F4. the fee-charged email server (22) informs the sender that application for an account is accepted, and the money for buying points has been charged from the credit card account;

F5. the sender searches the celebrity's email address from the website of the fee-charged email server (22) and checks the fee in points for obtaining an authorization code that will be needed for sending an email (4) to the celebrity, for example, the authorization code for sending an email to Bill Gates of the Microsoft may cost 500 points, and the sender may buy the authorization code with the points on the website;

F6. after verifying that the sender's point account is valid, the fee-charged email server (22) deducts the points needed for the authorization code from the sender's account, then forwards the sender a random authorization code which is unique, the sender copies this authorization code into the title of the email (4) within the designated time limit (such as a week), then sends the email (4) to the selected celebrity Bill Gates' email address at the fee-charged email server (22);

F7. within the designated time limit, the sender writes an email (4) entitled with the authorization code and sends it to the selected celebrity Bill Gates' email address at the fee-charged email server (22), and after receiving the email (4), the charged email server (22) compares the authorization code within the title of the email (4) with the authorization code issued in step F6, and if the two codes are consistent, stores the email (4) into the email box of the selected celebrity Bill Gates, and then deletes records of this authorization code, if there is no authorization code corresponding to the recipient within the title of the email received by the fee-charged email server (22), the fee-charged email server (22) disposes of this email and informs the sender by email that the sender must buy an authorization code in order to send the email (4) successfully;

F8. the celebrity Bill Gates logs on the fee-charged email server (22) to check the email (4);

F9. the fee-charged email server (22) forwards the email (4) sent from the sender to the celebrity Bill Gates to check.

Implementation of the disclosed examples would reduce the spamming of junk mails and reduce loss in productivity due to junk mails. In some examples, the email communication through all the email servers (2) and exchange centers (1) are authenticated with PKI digital certificate technology. Once the email server (2) is authorized, the emails (4) of all the users at this email server (2) would be authenticated. Thus, this approach would popularize the PKI digital certificate technology more effectively compared with the traditional approach of authenticating the user individually, since most users of the traditional approach do not understand thoroughly its installation and usage steps and even often make mistakes, thus they cannot make good use of the digital certificate. In some examples, the emails are authenticated by the email servers (2), and the users can send and receive emails (4) as usual without any setup. Thus, the PKI digital certificate technology is applied effectively and is also suitable for most users. As to any requirements for a digital signature and confidence, the sender can sign and encrypt the email (4), then send the email to the recipient through the exemplary system and method, and then the recipient decrypts this email and verifies the digital signature, which is safer and more trustworthy.

1. A system for preventing junk mails comprising
a sender email server (2-1);
a recipient email server (2-2);
a user terminal (3) for communicating email (4) through the sender email server (2-1) and the recipient email server 2-2;
an internet communication network (6) for forwarding the email (4); and
a digital certificate (5) for each of the sender email server (2-1) and the recipient email server (2-2) including a private key and a public key for configured to encrypt and decrypt the email (4) with authentication in order to identify email (4) that is junk.

2. The system of claim 1, further comprising an email authentication exchange center (1) configured with the digital certificate.

3. The system of claim 2, wherein:
the email authentication exchange center (1) is an email server configured with account management and authentication programs, and stores the public key for the digital certificate (5-2) of the sender email server (2-1) and the private key for its own digital certificate (5-1), the email authentication exchange center (1) is configured to decrypt the email (4) forwarded from the sender email server (2-1) with the public key for the digital certificate (5-2) of the sender email server (2), then encrypt the email (4) with the private key for the digital certificate (5-1) of its own, and then forward the encrypted email (4) to the recipient email server (2-2);
the recipient email server (2-2) is an email server configured with the digital certificate (5-2), and stores the private key for its own digital certificate (5-2) and the public key for the digital certificate (5-1) of the email authentication exchange center (1); the recipient email server (2-2) is in charge of encrypting the email (4) sent from the user terminal (3) with the private key for its own digital certificate (5-2), forwarding the encrypted email (4) to the email authentication exchange center (1), and decrypting the encrypted email (4) forwarded from the email authentication exchange center (1) with the public key for the digital certificate (5-1) of the email authentication exchange center (1), and then storing the email (4), which is successfully decrypted, into the user's email box, while the user may check the email (4) with the user terminal (3); and
the user terminal (3) is a terminal for the user to receive and send emails (4) and is selected from a group consisting of a computer, a PDA, and a cellular phone that is connected to the sender email server (2-1) and the recipient email server (2-2) via the internet communication network (6), and the user terminal (3) is configured with a program for receiving and sending emails by the user logging onto the sender email server (2-1) or the recipient email server (2-2) via the internet communication network (6), then checking or downloading the emails (4) in the user's email box through the program for receiving and sending emails, and sending an email (4).

4. A method for use in a system for preventing junk mails, the system including a sender email server (2-1), a recipient email server (2-2), a user terminal (3) for communicating email (4) through the sender email server (2-1) and the recipient email server 2-2, an internet communication network (6) for forwarding the email (4), and a digital certificate (5) for each of the sender email server (2-1) and the recipient email server (2-2) including a private key and a public key configured to encrypt and decrypt the email (4) with authentication in order to identify email (4) that is junk, the method comprising:
using the digital certificate (5) to encrypt and decrypt the email (4) with authentication in order to identify email (4) that is junk.

5. The method of claim 4, further including using an exchange center (1) to authenticate received email (4) that is forwarded from the sender email server (2-1) with the digital certificate (5-2) of the recipient email server (2-2), and using the recipient email server (2-2) to authenticate the received email (4) that is forwarded from the exchange center (1) with the digital certificate (5-1) of the exchange center (1).

6. The method of claim 5, further including:
arranging the exchange center (1) with of the sender email server (2-1) and the recipient email server (2-2), wherein the sender email server (2-1) and the recipient email server (2-2) are each configured with a program for processing encryption and decryption, the exchange center (1) applies for the digital certificate (5-1) from a digital certificate authentication center, and the respective recipient email server (2-2) also applies for a digital certificate (5-2) from the digital certificate authentication center, the respective email server (2) registers and stores at the exchange center (1) the public key of its own digital certificate (5-2) and a network domain name, the exchange center (1) also establishes a blacklist for any sender email server (2-1) that sends junk mails, and the exchange center (1) disposes of any emails (4) sent from any sender email server (2-1) on the blacklist;
when a user sending an email (4) via the sender email server (2-1), the sender email server (2-1) encrypts the email (4) sent by the user with the private key of its own digital certificate (5-2), then forwards the encrypted email to the exchange center (1), which decrypts the encrypted email with the public key of the digital certificate of the recipient email server (2-2), determines that the email is sent from the sender email server (2-1) if the decryption is successful, and after verifying that the sender email server (2-1) is not listed on the blacklist, the exchange center (1) encrypts the email (4) with the private key for its own digital certificate (5-1), then forwards the encrypted email to the recipient email server (2-2), which decrypts the received email with the public key for the digital certificate (5-1) of the exchange center (1) and determines that the email is forwarded from the exchange center (1) if the decryption is successful, and then stores the decrypted email (4) into the recipient's email box;
when receiving an email sent without being encrypted or an email sent from any sender email server (2-1) listed on the blacklist, the exchange center (1) disposes the email, revokes an account of any sender email server (2-1) that is subject to complaints about junk email and adds to the blacklist the name of the sender email sever (2-1) to prevent any future emails from being forwarded from the blacklisted sender email server (2-1); and
when the recipient email server (2-2) receives any email that is not forwarded from the exchange center (1) and is not encrypted with the digital certificate (5-1) of the exchange center (1), the recipient email server (2-2) stores that mail in a junk mail box.

7. The method of claim 6, wherein the sender sends and receives emails (4) with the user terminal (3) through the sender email server (2-1) of a first service provider, and the recipient receives and sends emails (4) with another user terminal (3) through the recipient email server (2-2) of a second service provider, and
A1. when the sender sends an email (4) to the recipient, the email (4) is forwarded to the sender email server (2-1) via the user terminal (3);
A2. the sender email server (2-1) encrypts this email (4) with the private key for its own digital certificate (5-2), then forwards the encrypted email to the exchange center (1);
A3. the exchange center (1) decrypts the received encrypted email with the public key for the digital certificate (5-2) of the sender email server (2-1), determines that the email is forwarded from the sender email server (2-1) if the decryption is successful, then encrypts this email (4) with the private key for its own digital certificate (5-1), and then forwards the encrypted email to the recipient email server (2-2);
A4. the recipient email server (2-2) decrypts the received encrypted email with the public key for the digital certificate (5-1) of the exchange center (1), determines that the email is forwarded from the exchange center (1) if the decryption is successful, and then stores the decrypted email (4) into the recipient's email box.

8. The method of claim 7, wherein the sender is in a first company and the recipient is in a second company, and the first company applies in advance for the digital certificate (5-3), then registers and stores at the exchange center (1) the public key for this digital certificate (5-3), and then stores the private key for the digital certificate (5-3) within the sender email server (2-1), and the second company also applies in advance for the digital certificate (5-3), then registers and stores at the exchange center (1) the public key for its digital certificate (5-3), and then stores the private key for the digital certificate (5-3) at the recipient email server (2-2).

9. (canceled)

10. The method of claim 8, further including step B5 wherein the sender pays a certain sum of money to the recipient for every email (4) sent to the recipient, and the exchange center (1) deducts the money from the first company on a monthly settlement basis, and deposits the money, after deducting a service charge, into a bank account of the second company.

11. The method of claim 6, further including a payment gateway (7) and the charge is settled via a bank account computer system (8), the exchange center (1) pays or deposits the money with transfers between the bank accounts of the first and second companies via the payment gateway (7), and the exchange center (1) deducts the service charge either at certain rate or of fixed amount from the money charged for sending and receiving emails (4), and
the exchange center (1) records a count of debt to the first company for sending any email and records income to the second company for receiving any email, and,
during the settlement, the exchange center (1) calculates the money to be paid or the money to be received by the sender email server (2-1) and the recipient email server (2-2) with the service charge deducted, then charges or deposits the money via transfer between the bank accounts of the first and second companies through the payment gateway (7) and the bank account computer system (8).

12. The method of claim 6, further including settling any charges using the bank account computer system (8) and an email charge inquiry website (9) for providing information related to any charges to email addresses of the sender email server (2-1), and the charges for any of the email address can be found through logging onto the email charge inquiry website and inputting the email address to be inquired, and any users are classified into two groups, where one group is designated as common email users, to whom the emails can be sent with a payment of a fixed charge, and the other group is designated as email users with a self-defined donation charge, wherein if a person wants to send emails (4) to the email boxes of the latter group, the person must pay the fixed charge and the self-defined donation charge, the email server (2) also stores the email address of the any user with the self-defined donation charge and the amount of money for of the donation charge into the email charge inquiry website (9), and owners of the email address can change the amount of money for the self-defined donation charge at will through the email charge inquiry website, and
E1. before sending an email (4) to the recipient, the sender logs onto the email charge inquiry website (9) and inputs the recipient's email address, then the sender determines the amount of money for the self-defined donation charge set by the recipient;
E2. if the sender accepts the self-defined donation charge, the sender forwards the email (4) to the sending server (2-1) via the user terminal (3);
E3. the sending server (2-1) encrypts the email (4) with the private key for its own digital certificate (5-2), then forwards the encrypted email (4) to the exchange center (1) and records this count of debt in a sender's account book;
E4. the exchange center (1) decrypts the received email (4) with the public key for the digital certificates (5-2) of the sending server (2-1), determines that the email is forwarded from the sending server (2-1) if the decryption is successful, records this count of debt into an account book of the sending server (2-1), then encrypts this email (4) with the private key for its own digital certificate (5-1), and then records this count of income into the account book of the receiving server (2-2);
E5. the receiving server (2-2) decrypts the received encrypted email with the public key for the digital certificate (5-1) of the exchange center (1), determines that the email is forwarded from the exchange center (1) if the decryption is successful, then records this count of income into the recipient's account book; the receiving server (2-2) verifies whether the recipient's email address is classified as one of the common email addresses or one one of the email addresses with the self-defined donation charge, if this recipient is a one of the common email addresses, the receiving server (2-2) stores the decrypted email (4) into the recipient's email box, ignores steps E6-E14, and skips to step E15, if the recipient has one of the email addresses with the self-defined donation charge, then the receiving server (2-2) temporarily stores the email (4) and proceeds to step E6;
E6. the receiving server (2-2) sends to the exchange center (1) a request to pay the self-defined donation charge, wherein the request includes the email sender's email address, the recipient's email address, title, date and time of that email;
E7; after receiving the request to pay the self-defined donation charge, the exchange center (1) searches out the recipient's email address from the request, then verifies the amount of money for the donation charged for the email address on the email inquiry charge website (9);
E8. the email inquiry charge website (9) verifies the request from the records in memory, then forwards to the exchange center (1) information about the amount of money for the self-defined donation;
E9. the exchange center (1) stores temporarily the information about the amount of money for the donation charge, replies to the sender with a reply email encrypted with the private key for its own digital certificate (5-1) that informs the sender the self-donation charge and a donation reference code and to remind the sender to pay the self-donation charge on-line via logging onto the website of the exchange center (1) within a designated time limit, wherein the donation reference code is a number for distinguishing different emails (4) when receiving the donation;
E10. the sender email server (2-1) decrypts the reply email with the public key for the digital key (5-1) of the exchange center (1), determines that the reply email is sent from the exchange center (1) if the decryption is successful, and stores the reply email into the sender's email box;
E11. when checking the sender's email box, the sender reads the content of the reply email, if the sender agrees to pay the self-donation, the sender, within the designated time limit, logs onto the website of the exchange center (1), and inputs the sender's email address and the payment reference code, the sender finds out on the website of the exchange center (1) the recipient's email address for the email (4) sent to the sending server (2-1) described in preceding step E2 and pays the self-defined donation charge;
E12. the exchange center (1) forwards through the payment gateway (7) the payment information and the total amount of money to the bank account computer system (8) and requests for transfer of the money;
E13. the bank account computer system (8) verifies the payment information and account balance and, if all information is valid, then transfers the money from the user's account provided in the payment information to the bank account of the exchange center (1), and then informs the exchange center (1) that the transfer is successful;
E14. the exchange center (1) forwards to the recipient email server (2-2) the received information about successful transfer for the payment, then the recipient email server (2-2) stores the decrypted email (4), which has been temporarily stored at step E5, into the recipient's email box for the recipient to check;
E15. during the settlement, the exchange center (1), based on record of receiving and sending emails at fixed charge for the respective email server (2), calculates the money to be paid or the money to be received by the sender email server (2-1) and the recipient email server (2-2) with deduction of the service charge from the respective account, then charges or deposits the money with transfer between the bank accounts of the sender email server (2-1) and the recipient email server (2-2) through the payment gateway (7) and the bank account computer system (8).

13. The method of claim 4, further comprising for establishing a website for a fee-charged email server (22) and assigning celebrities email boxes and email addresses which are open to the public such that those who want to send emails (4) to the celebrities firstly have to log onto the website of the fee-charged email server (22) and pay a certain fee, wherein:
F1. before sending any email (4) to one of the celebrities, the sender firstly has to open an account at the website of the fee-charged email server (22) and buy points at that website;
F2. the fee-charged email server (22) forwards to a bank card center (88) the sender's credit card number and an amount of money to be transferred for the payment;
F3. after checking that the payment information and an account balance are valid, the bank card center (88) transfers money from the sender's credit card to an account of the fee-charged email server (22), and informs the fee-charged email server (22) that the transfer is successful;
F4. the fee-charged email server (22) informs the sender that application for an account is accept, and the money for buying points has been charged from the sender's credit card;
F5. the sender searches for one of the celebrity's email address from the website of the fee-charged email server (22) and checks the fee in points for an authorization code needed to send email (4) to this celebrity, the sender buys the authorization code with the points that the sender has bought;
F6. after checking that the sender's account has enough points, the fee-charged email server (22) deducts the points needed for the authorization code from the sender's account, then forwards the sender a random authorization code which is unique, the sender writes this authorization code into the title of the email (4) within a designated time limit, then sends the email (4) to the selected celebrity's email address at the fee-charged email server (22);
F7. after receiving the email (4), the fee-charged email server (22) compares the authorization code within the title of the email (4) with the authorization code issued in step F6, if the two codes match, the fee-charged email server (22) stores the email (4) into the email box of the selected celebrity, and then deletes records of this authorization code, if there the authorization code is absent from the title of the email received by the fee-charged email server (22), the fee-charged email server (22) disposes this email and informs the sender that the sender must buy the authorization code for that celebrity;
F8. the selected celebrity logs on the charged email server (22) to check the email (4); and
F9. the fee-charged email server (22) forwards the email (4) sent from the sender to the celebrity to check.
